(19) United States
(12) Patent Application Publication
(10) Pub. No.: US 2025/0251501 A1
(43) Pub. Date: Aug. 7, 2025

(54) ELECTRONIC DEVICE INCLUDING SENSOR MODULE AND OPERATING METHOD THEREOF

(71) Applicant: SAMSUNG ELECTRONICS CO., LTD., Suwon-si (KR)

(72) Inventors: Gwangho CHOI, Suwon-si (KR); Jongah KIM, Suwon-si (KR); Heewoong YOON, Suwon-si (KR); Kihyuk LEE, Suwon-si (KR); Donghan LEE, Suwon-si (KR)

(73) Assignee: SAMSUNG ELECTRONICS CO., LTD., Suwon-si (KR)

(21) Appl. No.: 19/092,796

(22) Filed: Mar. 27, 2025

Related U.S. Application Data
(63) Continuation of application No. PCT/KR2023/013701, filed on Sep. 13, 2023.

(30) Foreign Application Priority Data
Sep. 27, 2022 (KR) 10-2022-0122895
Oct. 18, 2022 (KR) 10-2022-0134382

(51) Int. Cl. G01S 7/497; G01S 7/481; G01S 17/04

(52) U.S. Cl. CPC G01S 7/497; G01S 7/4815; G01S 7/4816; G01S 17/04; G01S 2007/4975

(57) ABSTRACT

An electronic device may include: a sensor configured to emit light, receive at least a portion of light incident, and sense whether an external object approaches; and a processor, wherein the sensor may include: a light emitter including light sources spaced configured to emit light; and a light receiver configured to receive at least a portion of the light incident, and wherein the processor is configured to: obtain, through the light receiver, a first signal corresponding to light output from the light sources in a first state in which the sensor is non-obstructed; compare a first value corresponding to the first signal with a second value stored in a memory; and control the light emitter to turn off at least one from among the light sources based on identifying that a difference between the first value and the second value exceeds a threshold.

### CROSS-REFERENCE TO RELATED APPLICATIONS

This application is a bypass continuation application of International Application No. PCT/KR2023/013701, filed on Sep. 13, 2023, which claims priority to Korean Application No. 10-2022-0122895, filed in the Korean Intellectual Property Office on Sep. 27, 2022, and Korean Application No. 10-2022-0134382, filed in the Korean Intellectual Property Office on Oct. 18, 2022, the contents of which are incorporated by reference herein in their entireties.

### BACKGROUND

### 1. Field

The disclosure relates to an electronic device, and more particularly, to an electronic device including a sensor module and/or a method for operating the same.

### 2. Description of Related Art

As electronics, information, or communication technology grows, an electronic device equipped with various functions has been provided. For example, smartphones include functionalities of a sound player, imaging device, and scheduler, as well as a communication functionality, and may further implement various other functions by having applications installed thereon. An electronic device may not only have its equipped applications or stored files but may also access, wiredly or wirelessly, a server or another electronic device to receive, in real-time, various pieces of information.

As electronic devices have higher performance and are downsized, the user may routinely use an electronic device while carrying it. Advances in information communication technology allow the electronic device to be further integrated, making it easier to carry and use the electronic device. The electronic device frequently used while being carried may be exposed to various operational environments. For example, the operational environment of the electronic device may be changed as the electronic device is moved indoors/outdoors or by changes in weather, and the electronic device may provide an optimal use environment to the user by controlling an output device such as a display according to the operational environment.

The above-described information may be provided as background for the purpose of helping understanding of the disclosure. No determination is made as to whether any of the foregoing is applicable as prior art in relation to the disclosure.

### SUMMARY

According to an aspect of the disclosure, an electronic device includes: a housing including a front surface facing in a first direction and a rear surface facing in a second direction opposite to the first direction; a display in the housing and configured to output a screen through at least a portion of the front surface; a sensor in the housing and configured to emit light through the front surface, receive at least a portion of light incident from an outside of the housing, and sense whether an external object approaches; a memory; and a processor, wherein the sensor may include: a light emitter including a plurality of light sources spaced apart from each other, the plurality of light sources configured to emit light through the front surface; and a light receiver configured to receive at least a portion of the light incident from the outside of the housing through the front surface, and wherein the processor may be configured to: obtain, through the light receiver, a first signal corresponding to light output from the plurality of light sources in a first state in which the sensor is non-obstructed; compare a first value corresponding to the first signal with a second value stored in the memory; and control the light emitter to turn off at least one from among the plurality of light sources based on identifying that a difference between the first value and the second value exceeds a threshold.

According to an aspect of the disclosure, a method for operating an electronic device may be provided. The electronic device may include a housing including a front surface facing in a first direction and a rear surface facing in a second direction opposite to a facing the first direction, a display in the housing and configured to output a screen through at least a portion of the front surface, and a sensor in the housing and configured to emit light through the front surface, receive at least a portion of light incident from an outside of the housing, and sense whether an external object approaches. The method may include: obtaining, through a light receiver of the sensor, a first signal corresponding to light output from a plurality of light sources, of a light emitter of the sensor, in a first state in which the sensor is non-obstructed; comparing a first value corresponding to the first signal with a second value stored in a memory of the electronic device; and controlling the light emitter to turn off at least one from among the plurality of light sources based on identifying that a difference between the first value and the second value exceeds a threshold, wherein the plurality of light sources spaced apart from each other and configured to emit light through the front surface, and wherein the light receiver is configured to receive at least a portion of the light incident from the outside of the housing through the front surface.

According to an aspect of the disclosure, a non-transitory computer readable medium may be provided and may include computer instructions that are configured to, when executed by at least one processor of an electronic device, cause the electronic device to: obtain, through a light receiver of a sensor of the electronic device, a first signal corresponding to light output from a plurality of light sources, of a light emitter of the sensor, in a first state in which the sensor is non-obstructed; compare a first value corresponding to the first signal with a second value stored in a memory of the electronic device; and control the light emitter to turn off at least one from among the plurality of light sources based on identifying that a difference between the first value and the second value exceeds a threshold, wherein the sensor is configured to sense whether an external object approaches.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment according to an embodiment of the disclosure;

FIG. 2 is a front perspective view illustrating an electronic device according to an embodiment of the disclosure;

FIG. 3 is a perspective view illustrating a rear surface of the electronic device of FIG. 2 according to an embodiment of the disclosure;

FIG. 4 is an exploded front perspective view illustrating the electronic device of FIG. 2, according to an embodiment of the disclosure;

FIG. 5 is a rear exploded perspective view illustrating the electronic device of FIG. 2 according to an embodiment of the disclosure;

FIG. 6 is an enlarged view illustrating a portion E in the electronic device of FIG. 2 according to an embodiment of the disclosure;

FIG. 7 is a view illustrating a portion of the electronic device, taken along a line A-A of FIG. 6, according to an embodiment of the disclosure;

FIG. 8 is a diagram illustrating a sensor module of an electronic device according to an embodiment of the disclosure;

FIG. 9 is a diagram illustrating a sensor module of an electronic device according to an embodiment of the disclosure;

FIG. 10 is a diagram illustrating a schematic structure of an electronic device according to an embodiment of the disclosure;

FIG. 11 is a diagram illustrating an operation of turning off at least one from among a plurality of light sources included in a sensor module by an electronic device according to an embodiment of the disclosure;

FIG. 12A is a flowchart illustrating an operation of turning off at least one from among a plurality of light sources included in a sensor module by an electronic device according to an embodiment of the disclosure;

FIG. 12B is a flowchart illustrating an operation of turning off at least one from among a plurality of light sources included in a sensor module by an electronic device according to an embodiment of the disclosure;

FIGS. 13A and 13B are diagrams illustrating an operation of turning off at least one from among a plurality of light sources included in a sensor module by an electronic device according to an embodiment of the disclosure;

FIG. 14 is a diagram illustrating an operation of turning off at least one from among a plurality of photodiodes included in a sensor module by an electronic device according to an embodiment of the disclosure; and

FIG. 15 is a flowchart illustrating an operation of turning off at least one from among a plurality of photodiodes included in a sensor module by an electronic device according to an embodiment of the disclosure.

### DETAILED DESCRIPTION

An electronic device may include various types of sensor modules for detecting an operational environment. For example, the electronic device may include a gyro sensor or a geomagnetic sensor to detect the current alignment direction, and may control operations of a display or various circuit devices based on information detected through a temperature sensor, a humidity sensor, a proximity sensor, and/or an illuminance sensor. The sensor module for detecting humidity, illuminance, or approach of the user's body may be disposed inside the electronic device and may be provided with a path through which external air may flow in or an incident path of light. The air inflow path or the light incident path may be at least partially exposed from the exterior of the electronic device. For example, according to a comparative embodiment, the electronic device may operate stably using various sensor modules, but the beauty of the exterior or the degree of freedom of the exterior design may be reduced. By minimizing the visual exposure of the air inflow path or the incident path of light, the appearance may be better, but the accuracy of the sensor module in detecting the operational environment may be decreased.

An embodiment of the disclosure aims to provide the advantages described below while addressing the foregoing issues and/or shortcomings and may provide an electronic device with enhanced accuracy in detecting the operational environment and/or a method for operating the same.

An embodiment of the disclosure may include an electronic device that may provide a better appearance while securing the detection accuracy of the operational environment and/or a method for operating the same.

Objects of the disclosure are not limited to the foregoing, and other unmentioned objects would be apparent to one of ordinary skill in the art from the following description.

The following description taken in conjunction with the accompanying drawings may provide an understanding of various example implementations of embodiments of the disclosure, including their equivalents. The specific embodiments described in the following description entail various specific details to aid understanding, but are regarded as one of various non-limiting example embodiments. Accordingly, it will be understood by those skilled in the art that various changes and modifications may be made to the various implementations described in the disclosure without departing from the spirit and scope of the disclosure. Further, descriptions of well-known functions and configurations may be omitted for clarity and brevity.

The terms and words used in the following description and claims are not limited to the bibliographical meaning, but may be used to clearly and consistently describe an embodiment of the disclosure. Therefore, it will be apparent to those skilled in the art that the following description of various implementations of the disclosure is provided only for the purpose of description, not for the purpose of limiting the disclosure.

The singular forms “a,” “an,” and “the” are intended to include the plural forms as well, unless the context clearly indicates otherwise. Thus, as an example, “a component surface” may be interpreted as including one or more of the surfaces of a component.

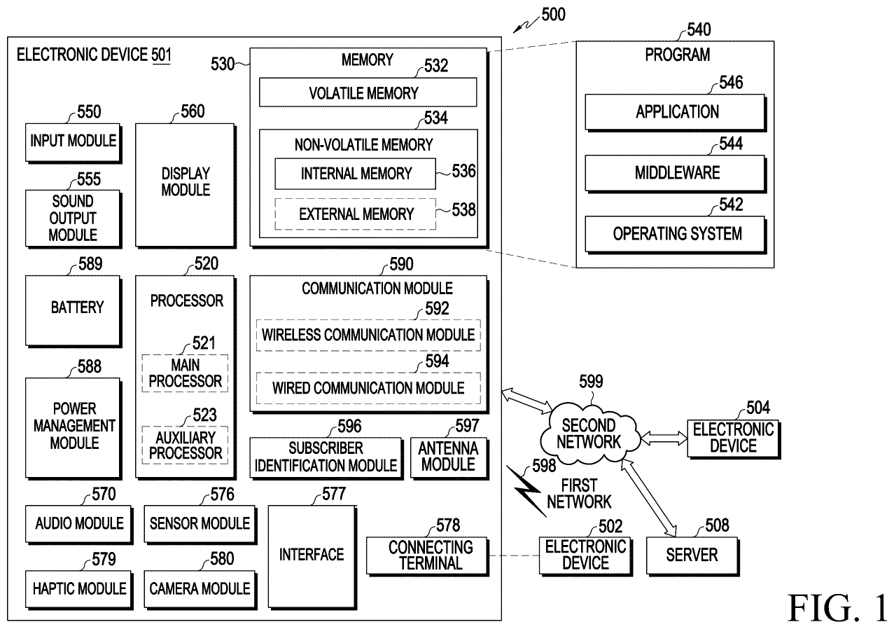

FIG. 1 is a block diagram illustrating an electronic device 501 in a network environment 500 according to various embodiments. Referring to FIG. 1, the electronic device 501 in the network environment 500 may communicate with at least one of an electronic device 502 via a first network 598 (e.g., a short-range wireless communication network), or an electronic device 504 or a server 508 via a second network 599 (e.g., a long-range wireless communication network). According to an embodiment, the electronic device 501 may communicate with the electronic device 504 via the server 508. According to an embodiment, the electronic device 501 may include a processor 520, memory 530, an input module 550, a sound output module 555, a display module 560, an audio module 570, a sensor module 576, an interface 577, a connecting terminal 578, a haptic module 579, a camera module 580, a power management module 588, a battery 589, a communication module 590, a subscriber identification module (SIM) 596, or an antenna module 597. In an embodiment, at least one (e.g., the connecting terminal 578) of the components may be omitted from the electronic device 501, or one or more other components may be added in the electronic device 501. According to an embodiment, some (e.g., the sensor module 576, the camera module 580, or the antenna module 597) of the components may be integrated into a single component (e.g., the display module 560).

The processor 520 may execute, for example, software (e.g., a program 540) to control at least one other component (e.g., a hardware or software component) of the electronic device 501 coupled with the processor 520, and may perform various data processing or computation. According to an embodiment, as at least part of the data processing or computation, the processor 520 may store a command or data received from another component (e.g., the sensor module 576 or the communication module 590) in volatile memory 532, process the command or the data stored in the volatile memory 532, and store resulting data in non-volatile memory 534. According to an embodiment, the processor 520 may include a main processor 521 (e.g., a central processing unit (CPU) or an application processor (AP)), or an auxiliary processor 523 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 501 includes the main processor 521 and the auxiliary processor 523, the auxiliary processor 523 may be configured to use lower power than the main processor 521 or to be specified for a designated function. The auxiliary processor 523 may be implemented as separate from, or as part of the main processor 521.

The auxiliary processor 523 may control at least some of functions or states related to at least one component (e.g., the display module 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). According to an embodiment, the auxiliary processor 523 (e.g., an image signal processor or a communication processor) may be implemented as part of another component (e.g., the camera module 580 or the communication module 590) functionally related to the auxiliary processor 123. According to an embodiment, the auxiliary processor 523 (e.g., the neural processing unit) may include a hardware structure specified for artificial intelligence model processing. The artificial intelligence model may be generated via machine learning. Such learning may be performed, e.g., by the electronic device 501 where the artificial intelligence is performed or via a separate server (e.g., the server 508). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534.

The program 540 may be stored in the memory 530 as software, and may include, for example, an operating system (OS) 542, middleware 544, or an application 546.

The input module 550 may receive a command or data to be used by other component (e.g., the processor 520) of the electronic device 501, from the outside (e.g., a user) of the electronic device 501. The input module 550 may include, for example, a microphone, a mouse, a keyboard, keys (e.g., buttons), or a digital pen (e.g., a stylus pen).

The sound output module 555 may output sound signals to the outside of the electronic device 501. The sound output module 555 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 560 may visually provide information to the outside (e.g., a user) of the electronic device 501. The display 560 may include, for example, a display, a hologram device, or a projector and control circuitry to control a corresponding one of the display, hologram device, and projector. According to an embodiment, the display 560 may include a touch sensor configured to detect a touch, or a pressure sensor configured to measure the intensity of a force generated by the touch.

The audio module 570 may convert a sound into an electrical signal and vice versa. According to an embodiment, the audio module 570 may obtain the sound via the input module 550, or output the sound via the sound output module 555 or a headphone of an external electronic device (e.g., an electronic device 502) directly (e.g., wiredly) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. According to an embodiment, the sensor module 576 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device (e.g., the electronic device 502) directly (e.g., wiredly) or wirelessly. According to an embodiment, the interface 577 may include, for example, a high definition multimedia interface (HDMI), a universal serial bus (USB) interface, a secure digital (SD) card interface, or an audio interface.

A connecting terminal 578 may include a connector via which the electronic device 501 may be physically connected with the external electronic device (e.g., the electronic device 502). According to an embodiment, the connecting terminal 578 may include, for example, a HDMI connector, a USB connector, a SD card connector, or an audio connector (e.g., a headphone connector).

The haptic module 579 may convert an electrical signal into a mechanical stimulus (e.g., a vibration or motion) or electrical stimulus which may be recognized by a user via his tactile sensation or kinesthetic sensation. According to an embodiment, the haptic module 579 may include, for example, a motor, a piezoelectric element, or an electric stimulator.

The camera module 580 may capture a still image or moving images. According to an embodiment, the camera module 580 may include one or more lenses, image sensors, image signal processors, or flashes.

The power management module 588 may manage power supplied to the electronic device 501. According to an embodiment, the power management module 588 may be implemented as at least part of, for example, a power management integrated circuit (PMIC).

The battery 589 may supply power to at least one component of the electronic device 501. According to an embodiment, the battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the application processor (AP)) and supports a direct (e.g., wired) communication or a wireless communication. According to an embodiment, the communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device 504 via a first network 598 (e.g., a short-range communication network, such as Bluetooth™, wireless-fidelity (Wi-Fi) direct, or infrared data association (IrDA)) or a second network 599 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 592 may identify or authenticate the electronic device 501 in a communication network, such as the first network 598 or the second network 599, using subscriber information (e.g., international mobile subscriber identity (IMSI)) stored in the subscriber identification module 596.

The wireless communication module 592 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 592 may support a high-frequency band (e.g., the mmWave band) to achieve, e.g., a high data transmission rate. The wireless communication module 592 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 592 may support various requirements specified in the electronic device 501, an external electronic device (e.g., the electronic device 504), or a network system (e.g., the second network 599). According to an embodiment, the wireless communication module 592 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 597 may transmit or receive a signal or power to or from the outside (e.g., the external electronic device). According to an embodiment, the antenna module 597 may include one antenna including a radiator formed of a conductor or conductive pattern formed on a substrate (e.g., a printed circuit board (PCB)). According to an embodiment, the antenna module 597 may include a plurality of antennas (e.g., an antenna array). In this case, at least one antenna appropriate for a communication scheme used in a communication network, such as the first network 598 or the second network 599, may be selected from the plurality of antennas by, e.g., the communication module 590. The signal or the power may then be transmitted or received between the communication module 590 and the external electronic device via the selected at least one antenna. According to an embodiment, other parts (e.g., radio frequency integrated circuit (RFIC)) than the radiator may be further formed as part of the antenna module 597.

According to various embodiments, the antenna module 597 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 501 and the external electronic device 504 via the server 508 coupled with the second network 599. The external electronic devices 502 or 504 each may be a device of the same or a different type from the electronic device 501. According to an embodiment, all or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 501. The electronic device 501 may provide the outcome, with or without further processing of the outcome, as at least part of a reply to the request. To that end, a cloud computing, distributed computing, mobile edge computing (MEC), or client-server computing technology may be used, for example. The electronic device 501 may provide ultra low-latency services using, e.g., distributed computing or mobile edge computing. In another embodiment, the external electronic device 504 may include an Internet-of-things (IoT) device. The server 508 may be an intelligent server using machine learning and/or a neural network. According to an embodiment, the external electronic device 504 or the server 508 may be included in the second network 599. The electronic device 501 may be applied to intelligent services (e.g., smart home, smart city, smart car, or health-care) based on 5G communication technology or IoT-related technology.

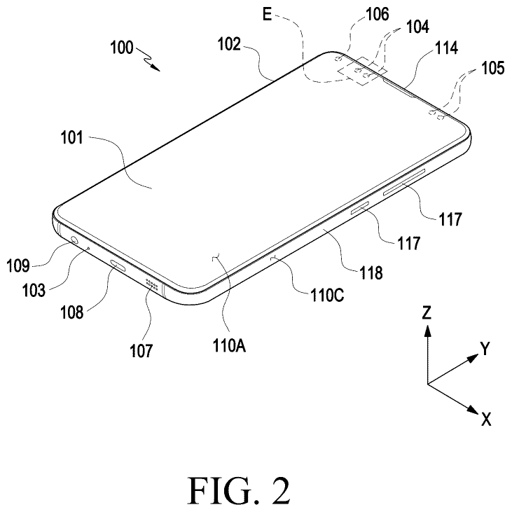

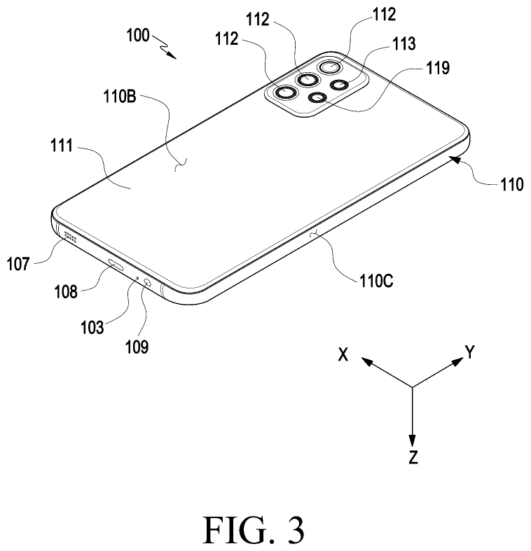

FIG. 2 is a front perspective view illustrating an electronic device 100 according to an embodiment of the disclosure. FIG. 3 is a perspective view illustrating a rear surface of the electronic device 100 of FIG. 2 according to an embodiment of the disclosure.

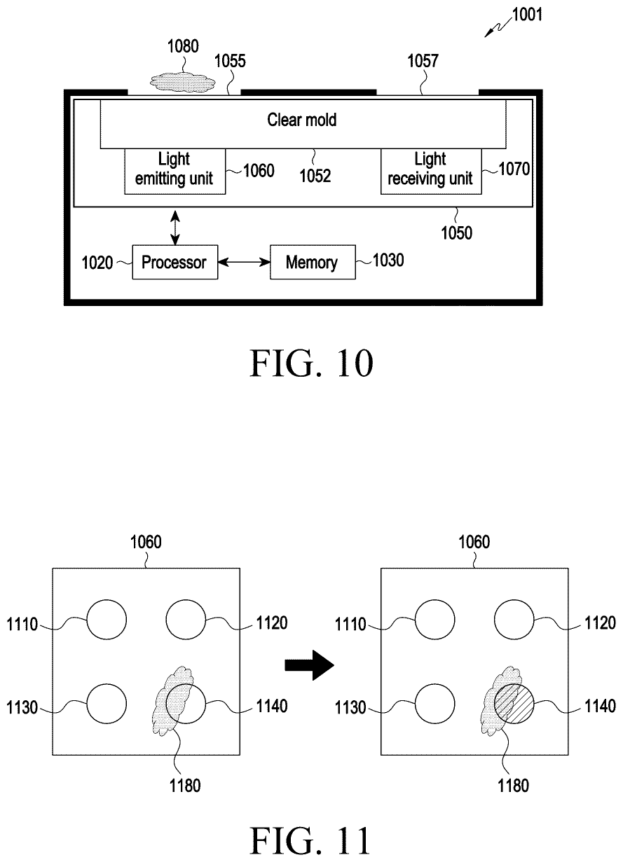

Referring to FIGS. 2 and 3, an electronic device 100 (e.g., the electronic device 501 of FIG. 1 or the electronic device 1001 of FIG. 10) according to an embodiment may include a housing 110 including a first surface 110A (e.g., a front surface), a second surface 110B (e.g., a rear surface), and a side surface 110C surrounding a space between the first surface 110A and the second surface 110B. According to an embodiment, the housing 110 may denote a structure forming the first surface 110A of FIG. 2, the second surface 110B of FIG. 3, and some of the side surfaces 110C. According to an embodiment, at least part of the first surface 110A may have a front plate 102 (e.g., a glass plate or polymer plate including various coat layers) that is substantially transparent. The second surface 110B may be formed of a rear plate 111 that is substantially opaque. The rear plate 111 may be formed of, for example, laminated or colored glass, ceramic, polymer, metal (e.g., aluminum, stainless steel (STS), or magnesium), or a combination of at least two thereof. The side surface 110C may be formed by a side structure 118 (e.g., a side bezel structure) that couples to the front plate 102 and the rear plate 111 and includes a metal and/or polymer. In an embodiment, the rear plate 111 and the side structure 118 may be integrally formed together and include the same material (e.g., a metal, such as aluminum).

According to embodiments, the front plate 102 may include an area(s) that bend from at least a portion of an edge toward the rear plate 111 and seamlessly extend. In an embodiment, only one of the areas of the front plate 102 (or the rear plate 111), which bend to the rear plate 111 (or front plate 102) and extend may be included in one edge of the first surface 110A. According to an embodiment, the front plate 102 or rear plate 111 may be substantially flat and, in this case, may not include an area bending and extending. When an area bending and extending is included, the thickness of the electronic device 100 at the portion including the area bending and extending may be smaller than the thickness of the rest.

According to an embodiment, the electronic device 100 may include at least one from among a display 101, an audio module (e.g., the microphone hole 103, the external speaker hole 107, and the phone receiver hole 114), a sensor module (e.g., the first sensor module 104, the second sensor module, or the third sensor module 119), a camera module (e.g., the first camera device 105, the second camera device 112, or the flash 113), a key input device 117, a light emitting device 106, and a connector hole (e.g., the first connector hole 108 or the second connector hole 109). In an embodiment, the electronic device 100 may exclude at least one (e.g., the key input device 117 or the light emitting device 106) of the components or may add other components.

The display 101 may output a screen or be visually exposed through a significant portion of the first surface 110A (e.g., the front plate 102), for example. In an embodiment, at least a portion of the display 101 may be visually exposed through the front plate 102 forming the first surface 110A, or through a portion of the side surface 110C. In an embodiment, the edge of the display 101 may be formed to be substantially the same in shape as an adjacent outer edge of the front plate 102. In an embodiment, the interval between the outer edge of the display 101 and the outer edge of the front plate 102 may remain substantially even to give a larger area of visual exposure of the display 101.

In an embodiment, a recess or an opening may be formed in a portion of the screen display area of the display 101, and there may be included at least one from among an audio module (e.g., the phone receiver hole 114), a sensor module (e.g., the first sensor module 104), a camera module (e.g., the first camera device 105), and a light emitting device 106 that are aligned with the recess or the opening. In an embodiment, at least one of the audio module (e.g., the phone receiver hole 114), sensor module (e.g., the first sensor module 104), camera module (e.g., the first camera device 105), fingerprint sensor, and light emitting device 106 may be included on the rear surface of the screen display area of the display 101. In an embodiment, the display 101 may be disposed to be coupled with, or adjacent, a touch detecting circuit, a pressure sensor capable of measuring the strength (pressure) of touches, and/or a digitizer for detecting a magnetic field-type stylus pen. In an embodiment, when the front plate 102 or the rear plate 111 includes a bent and extended area, at least some of the sensor modules (e.g., the first sensor module 104 and the third sensor module 119) and/or at least some of the key input devices 117 may be disposed in the bent and extended area(s).

The audio modules may include a microphone hole 103 and speaker holes (e.g., the external speaker hole 107 and the phone receiver hole 114). A microphone for acquiring external sounds may be disposed in the microphone hole 103. In an embodiment, a plurality of microphones may be disposed to detect the direction of the sound. The speaker holes may include an external speaker hole 107 and a phone receiver hole 114. According to an embodiment, the speaker holes (e.g., the external speaker hole 107 and the phone receiver hole 114) and the microphone hole 103 may be implemented as a single hole, or speakers may be included without the speaker holes (e.g., the external speaker hole 107 and the phone receiver hole 114) (e.g., piezo speakers).

The sensor module may generate an electrical signal or data value corresponding to an internal operating state or external environmental state of the electronic device 100. The sensor modules may include a first sensor module (e.g., a proximity sensor) and/or a second sensor module (e.g., a fingerprint sensor) disposed at (e.g., in or on) the first surface 110A of the housing 110 and/or a third sensor module 119 disposed at (e.g., in or on) the second surface 110B of the housing 110. The second sensor module (e.g., a fingerprint sensor) may be disposed at (e.g., in or on) the second surface 110B or side surface 110C as well as the first surface 110A (e.g., the display 101) of the housing 110. The electronic device 100 may further include, for example, at least one from among a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, and an illuminance sensor.

The camera modules may include a first camera device 105 disposed at (e.g., in or on) the first surface 110A of the electronic device 100, and a second camera device 112 and/or a flash 113 disposed at (e.g., in or on) the second surface 110B. The camera devices (e.g., the first camera device 105 and the second camera device 112) may include one or more lenses, an image sensor, and/or an image signal processor. The flash 113 may include, for example, a light emitting diode or a xenon lamp. In an embodiment, one or more lenses (an infrared (IR) camera, a wide-angle lens, and a telephoto lens) and image sensors may be disposed at (e.g., in or on) one surface of the electronic device 100. In an embodiment, flash 113 may emit infrared light. The infrared light emitted by the flash 113 and reflected by the subject may be received through the third sensor module 119. The electronic device 100 or the processor (e.g., the processor 520 of FIG. 1 or the processor 1020 of FIG. 10) of the electronic device 100 may detect depth information about the subject based on the time point when the infrared light is received from the third sensor module 119.

The key input device 117 may be disposed at (e.g., in or on) the side surface 110C of the housing 110. In an embodiment, the electronic device 100 may exclude all or some of the key input devices 117 mentioned above, and the key input devices 117 that are excluded may be implemented in other forms such as, for example, as soft keys, on the display 101. In an embodiment, the key input device may include the sensor module disposed at (e.g., in or on) the second surface 110B of the housing 110.

The light emitting device 106 may be disposed at (e.g., in or on), for example, the first surface 110A of the housing 110. The light emitting device 106 may provide, for example, information about the state of the electronic device 100 in the form of light. In an embodiment, the light emitting device 106 may provide a light source that interacts with, for example, the camera module (e.g., the first camera device 105). The light emitting device 106 may include, for example, a light emitting diode (LED), an infrared (IR) LED, or a xenon lamp.

The connector holes may include, for example, a first connector hole 108 for receiving a connector (e.g., a USB connector) for transmitting/receiving power and/or data to/from an external electronic device (e.g., the electronic device 502 of FIG. 1) and/or a second connector hole 109 (e.g., an earphone jack) for receiving a connector for transmitting/receiving audio signals to/from the external electronic device.

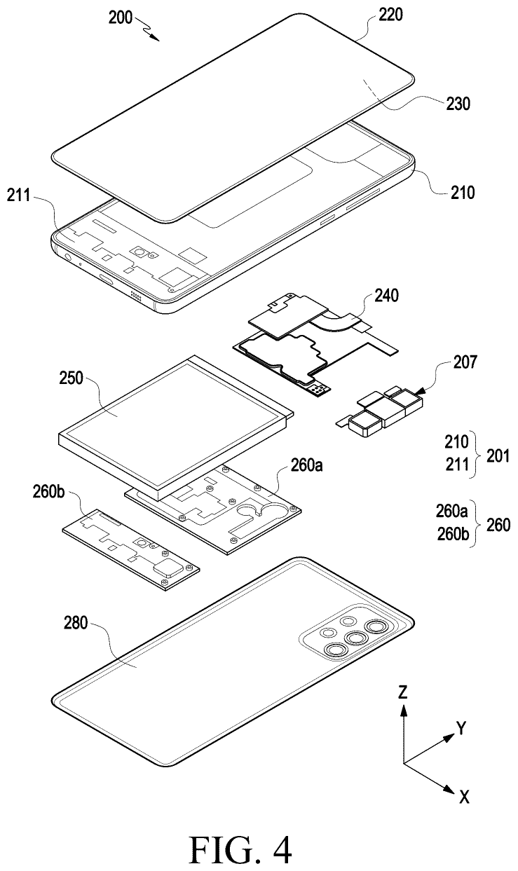

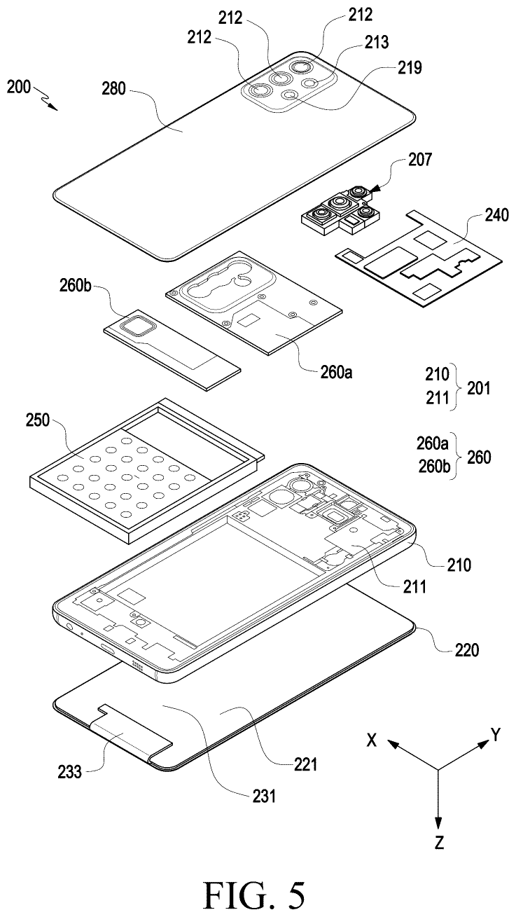

FIG. 4 is an exploded front perspective view illustrating the electronic device 200 of FIG. 2, according to an embodiment of the disclosure. FIG. 5 is a rear exploded perspective view illustrating the electronic device 200 of FIG. 2 according to an embodiment of the disclosure.

Referring to FIGS. 4 and 5, an electronic device 200 (e.g., the electronic device 501, 502, 504, 100, or 1001 of FIG. 1, 2, 3, or 10) may include a side structure 210, a first support member 211 (e.g., a bracket), a front plate 220 (e.g., the front plate 102 of FIG. 1), a display 230 (e.g., the display 560 of FIG. 1), a printed circuit board (or a board assembly) 240, a battery 250, a second support member 260 (e.g., a rear case), an antenna, a camera assembly 207, and a rear plate 280 (e.g., the rear plate 111 of FIG. 3). In an embodiment, the electronic device 200 may exclude at least one (e.g., the first support member 211 or the second support member 260) of the components or may add other components. At least one of the components of the electronic device 200 may be the same or similar to at least one of the components of the electronic device 100 of FIG. 2 or 3 and no repeated description thereof may be made below.

The first support member 211 may be disposed inside the electronic device 200 to be connected to the side surface structure 210 or integrated with the side surface structure 210. The first support member 211 may be formed of, for example, a metal and/or non-metallic material (e.g., polymer). When at least partially formed of a metallic material, a portion of the side structure 210 or the first support member 211 may function as an antenna. The display 230 may be joined onto one surface of the first support member 211, and the printed circuit board 240 may be joined onto the opposite surface of the first support member 232. A processor (e.g., the processor 520 of FIG. 1 or the processor 1020 of FIG. 10), memory (e.g., the memory 530 of FIG. 1 or the memory 1030 of FIG. 10), and/or an interface (e.g., the interface 577 of FIG. 1) may be mounted on the printed circuit board 240. The processor may include one or more of, for example, a central processing unit, an application processor, a graphic processing device, an image signal processing, a sensor hub processor, or a communication processor.

According to various embodiments, the first support member 211 and the side structure 210 may be collectively referred to as a front case or a housing 201. According to an embodiment, the housing 201 may be generally understood as a structure for receiving, protecting, or disposing the printed circuit board 240 or the battery 250. In an embodiment, the housing 201 may be understood as including a structure that the user may visually or tactfully recognize from the exterior of the electronic device 200 such as, for example, the side structure 210, the front plate 220, and/or the rear plate 280. In an embodiment, the “front or rear surface of the housing 201” may mean the first surface 110A of FIG. 2 or the second surface 110B of FIG. 3. In an embodiment, the first support member 211 may be disposed between the front plate 220 (e.g., the first surface 110A of FIG. 2) and the rear plate 280 (e.g., the second surface 110B of FIG. 3) and may function as a structure for placing an electrical/electronic component, such as the printed circuit board 240 or the camera assembly 207.

The display 230 may include a display panel 231 and a flexible printed circuit board 233 extending from the display panel 231. It may be understood that the flexible printed circuit board 233 is, for example, electrically connected to the display panel 231 while at least partially disposed on the rear surface of the display panel 231. In an embodiment, a protective sheet may disposed on the rear surface of the display panel 231. For example, the protective sheet may be understood as a portion of the display panel 231 unless otherwise designated in the detailed description below. In an embodiment, the protective sheet may function as a cushioning structure that absorbs external force (e.g., a low-density elastic material, such as a sponge) or an electromagnetic shielding structure (e.g., a copper (Cu) sheet). According to an embodiment, the display 230 may be disposed on the inner surface of the front plate 220 and, by including a light emitting layer, output a screen through at least a portion of the front plate 220 or the first surface 110A of FIG. 2. As mentioned above, the display 230 may output substantially the entire area of the front plate 220 or the first surface 110A of FIG. 2.

The memory may include, for example, a volatile or non-volatile memory.

The interface may include, for example, a high definition multimedia interface (HDMI), a universal serial bus (USB) interface, a secure digital (SD) card interface, and/or an audio interface. The interface may electrically or physically connect, for example, the electronic device 200 with an external electronic device and may include a USB connector, an SD card/multimedia card (MMC) connector, or an audio connector.

The second support member 260 may include, for example, an upper support member 260a and a lower support member 260b. In an embodiment, the upper support member 260a, together with a portion of the first support member 211, may be disposed to surround the printed circuit board 240. A circuit device (e.g., a processor, a communication module, or memory) implemented in the form of an integrated circuit chip or various electrical/electronic components may be disposed on the printed circuit board 240. According to an embodiment, the printed circuit board 240 may receive an electromagnetic shielding environment from the upper support member 260a. In an embodiment, the lower support member 260b may be utilized as a structure in which electrical/electronic components, such as a speaker module and an interface (e.g., a USB connector, an SD card/MMC connector, or an audio connector), may be disposed. In an embodiment, electrical/electronic components, such as a speaker module and an interface (e.g., a USB connector, an SD card/MMC connector, or an audio connector), may be disposed on an additional printed circuit board. In this case, the lower support member 260b, together with the other part of the first support member 211, may be disposed to surround the additional printed circuit board. A speaker module or interface disposed on an additional printed circuit board or lower support member 260b may be disposed corresponding to the connector hole (e.g., the first connector hole 108 or the second connector hole 109) or the audio module (e.g., the microphone hole 103 or the speaker hole (e.g., the external speaker hole 107 or the phone receiver hole 114)) of FIG. 2.

The battery 250 may be a device for supplying power to at least one component of the electronic device 200. The battery 250 may include, for example, a primary cell which is not rechargeable, a secondary cell which is rechargeable, or a fuel cell. At least a portion of the battery 250 may be disposed on substantially the same plane as the printed circuit board 240. The battery 250 may be integrally or detachably disposed inside the electronic device 200.

According to embodiments, the antenna may include a conductor pattern implemented on the surface of the second support member 260 through, for example, laser direct structuring. In an embodiment, the antenna may include a printed circuit pattern formed on the surface of the thin film. The thin film-type antenna may be disposed between the rear plate 280 and the battery 250. The antenna may include, for example, a near-field communication (NFC) antenna, a wireless charging antenna, and/or a magnetic secure transmission (MST) antenna. The antenna may perform short-range communication with, for example, an external device or may wirelessly transmit or receive power necessary for charging. In an embodiment of the disclosure, another antenna structure may be formed by a portion or combination of the side structure 210 and/or the first support member 211.

The camera assembly 207 may include at least one camera module. Inside the electronic device 200, the camera assembly 207 may receive at least a portion of the light incident through the optical hole or the camera windows 212, 213, and 219. In an embodiment, the camera assembly 207 may be disposed on the first support member 211 in a position adjacent to the printed circuit board 240. In an embodiment, the camera module(s) of the camera assembly 207 may be generally aligned with either one of the camera windows 212, 213, and 219 and be a least partially surrounded by the second support member 260 (e.g., the upper support member 260a).

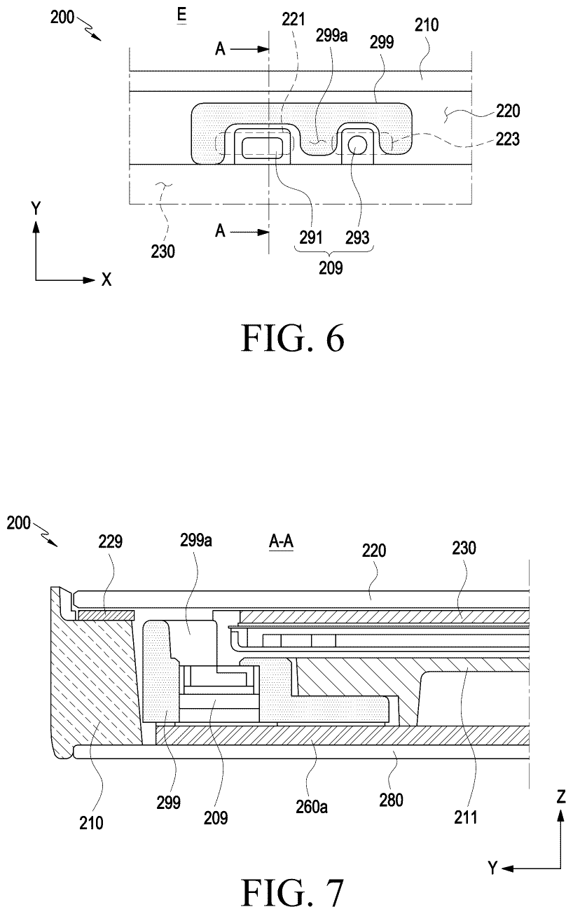

Hereinafter, a disposition of a sensor module (e.g., the first sensor module 104 of FIG. 2 or the sensor module 209 of FIG. 6) is described with reference to FIGS. 6 and 7. In describing the disposition of the sensor module, reference may be made to the electronic devices 501, 1001, 100, and 200 of FIGS. 1, 5, and 10, and the same reference numerals in the drawings may be assigned to the components that may be easily understood through the preceding embodiments, or may be omitted, and a repeated description thereof may also be omitted. In an embodiment, the electronic devices 501, 1001, 100, and 200 of FIGS. 1, 5, and 10 may be combined with the structure, disposition, and/or operation of the sensor module described below. In the illustrated drawings or embodiments, a configuration in which a sensor module is disposed on one side of a display (e.g., the display 101 or 230 of FIGS. 2, 4 to 7) is disclosed, but it should be noted that the embodiment(s) of the disclosure are not limited thereto. For example, depending on the structure or specifications (e.g., size) of the sensor module, the sensor module may be disposed to overlap the screen display area of the display. In an embodiment, when the sensor module is disposed to overlap the screen display area, some of the pixels of the display may transmit light emitted from the sensor module or light incident on the sensor module.

FIG. 6 is an enlarged view illustrating a portion E in the electronic device of FIG. 2 according to an embodiment of the disclosure. FIG. 7 is a view illustrating a portion of the electronic device, taken along a line A-A of FIG. 6, according to an embodiment of the disclosure.

Referring to FIGS. 6 and 7, the electronic device 200 may include a sensor module 209 (e.g., the first sensor module 104 of FIG. 2) that emits light to the outside or receives external light through an area between the side structure 210 and the display 230. In an embodiment, the sensor module 209 may be disposed inside the electronic device 200 while being mounted on a guide member 299. The guide member 299 may be at least partially accommodated in, for example, an opening portion of the first support member 211. In an embodiment, the guide member 299 may be at least partially fixed between the first support member 211 and the upper support member 260a.

According to an embodiment, the sensor module 209 may include a light emitting unit 291 (e.g., a light emitter) and a light receiving unit 293 (e.g., a light receiver). For example, the sensor module 209 may emit light to the outside using the light emitting unit 291, and when the emitted light is reflected by an external object, the sensor module 209 may receive at least a portion of the reflected light using the light receiving unit 293, thereby detecting whether the external object approaches or a distance from the external object. In an embodiment, the guide member 299 may include a partition 299a disposed between the light emitting unit 291 and the light receiving unit 293. The partition 299a may suppress, for example, light output from the light emitting unit 291 from being reflected, refracted, or scattered inside the electronic device and input to the light receiving unit 293 without being radiated to the outside. For example, as the partition 299a is disposed, the accuracy of the sensor module 209 may be enhanced in detecting whether an external object approaches or a distance from the external object.

According to an embodiment, the front plate 220 (e.g., a window) may include a painted layer disposed on an inner surface (or an outer surface) in the remaining area except for the screen display area of the display 230. For example, the painted layer may block other structures inside the electronic device 200 except for the screen display area of the display 230 from being visually exposed to the outside through the front plate 220. The term “other structure inside the electronic device 200” may include an adhesive member 229 (e.g., a double-sided tape) and/or a guide member 299 for bonding the front plate 220 to the side structure 210.

According to an embodiment, the painted layer may provide openings such as, for example, slits (e.g., a first slit 221 and a second slit 223) (or slots) that transmit light in an area facing the sensor module 209 (e.g., the light emitting unit 291 or the light receiving unit 293). In the embodiment of FIG. 6, the painted layer may provide a first slit 221 corresponding to the light emitting unit 291 and a second slit 223 corresponding to the light receiving unit 293. For example, the sensor module 209 may radiate light to the outside through the first slit 221 and may receive light incident through the second slit 223.

According to an embodiment, since the slits (e.g., the first slit 221 and the second slit 223) provide a path through which light passes, the slits (e.g., the first slit 221 and the second slit 223) may be visually recognized by the user. For example, in a comparative embodiment, by being visually exposed from the exterior of the electronic device 200, slits may degrade the exterior of an electronic device or may degrade the degree of freedom of design of the exterior. The slits (e.g., the first slit 221 and the second slit 223) may have a minimized width or length within a range allowing light to be emitted or incident, thereby suppressing deterioration of the exterior quality of the electronic device 200.

According to an embodiment, as the width (or length) is reduced, the amount of light passing through the slits (e.g., the first slit 221 and the second slit 223) may be reduced. For example, the sensor module 209 (e.g., the light emitting unit 291) may emit a larger amount of light to detect external environment information. In an embodiment, the light emitting unit 291 may include a vertical-cavity surface-emitting laser (VCSEL). An angle range (hereinafter, referred to as a “radiation angle”) at which a vertical-cavity surface-emitting laser emits light may be relatively small compared to other light sources such as an infrared light emitting diode.

In an embodiment, in radiating light to the outside through the slits (e.g., the first slit 221 and the second slit 223) (e.g., the first slit 221) having a reduced width or length, the vertical-cavity surface-emitting laser may provide higher light efficiency or higher power efficiency than other light sources. For example, the embodiment(s) of the disclosure may enhance the accuracy or power efficiency of the sensor module 209 in detecting information about the external environment while making the external appearance of the electronic device 200 better.

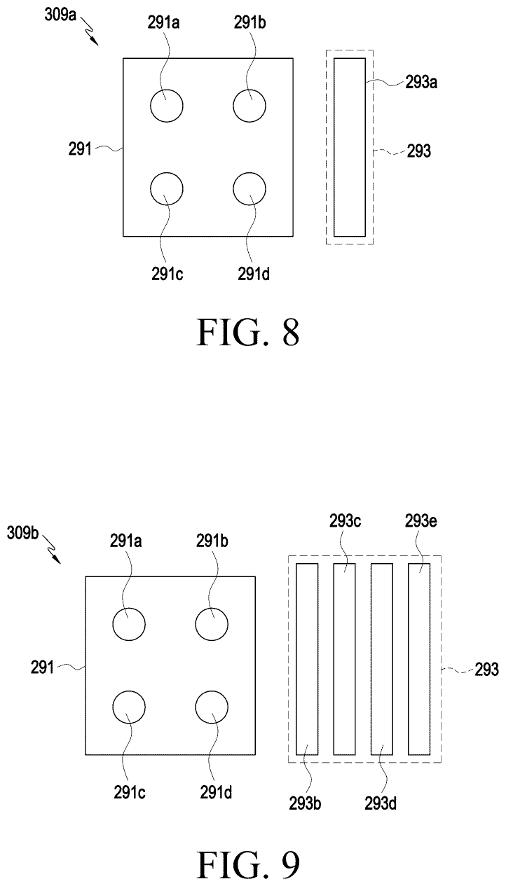

According to a comparative embodiment, as the light emitting unit 291 has a small radiation angle and the widths of the slits (e.g., the first slit 221 and the second slit 223) are reduced, the accuracy of the sensor module 209 may have a deviation due to contamination in an actual use environment. The term “contamination in an actual use environment” refers to contamination by oil due to user contact and/or contamination by external foreign substances such as dust. According to an embodiment(s) of the disclosure, the sensor module 209 (e.g., the light emitting unit 291) may include a plurality of light emitting devices (e.g., pixels), thereby suppressing an accuracy deviation of the sensor module 209 that may occur in an actual use environment. The configuration of the sensor module 209 and/or the light emitting unit 291 is further described with reference to FIG. 8.

FIG. 8 is a diagram illustrating a sensor module of an electronic device according to an embodiment of the disclosure.

Referring further to FIG. 8, a sensor module (e.g., the first sensor module 104 of FIG. 2 or the sensor module 209 of FIGS. 6 and 7) and/or a light emitting unit 291 may include a plurality of (e.g., four) light emitting devices 291a, 291b, 291c, and 291d. In the sensor module 209 and/or the light emitting unit 291, the plurality of light emitting devices 291a, 291b, 291c, and 291d may be arranged in a 1×4 array, a 4×1 array, or a 2×2 array. The arrangement of the light emitting devices 291a, 291b, 291c, and 291d may vary depending on the number thereof, and it should be noted that the number and arrangement of the light emitting devices 291a, 291b, 291c, and 291d listed herein do not limit the embodiment(s) of the disclosure.

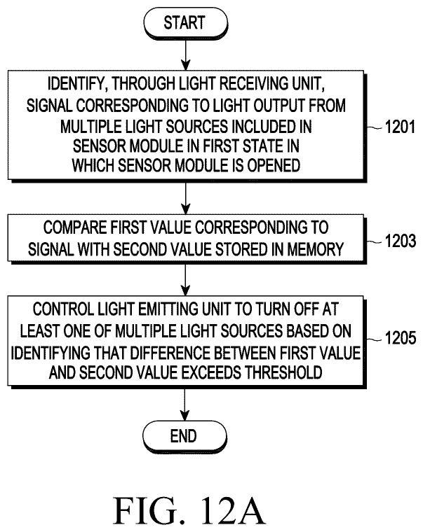

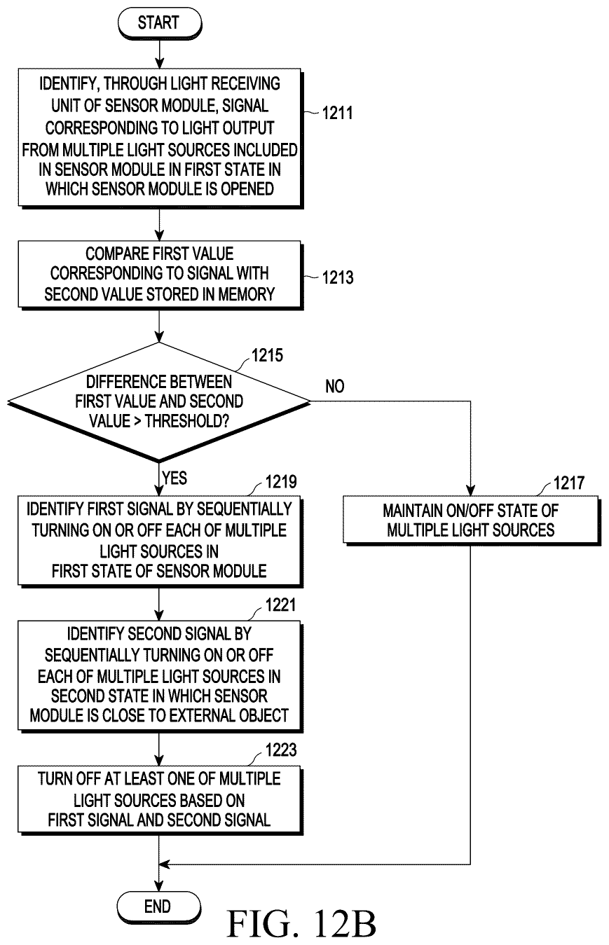

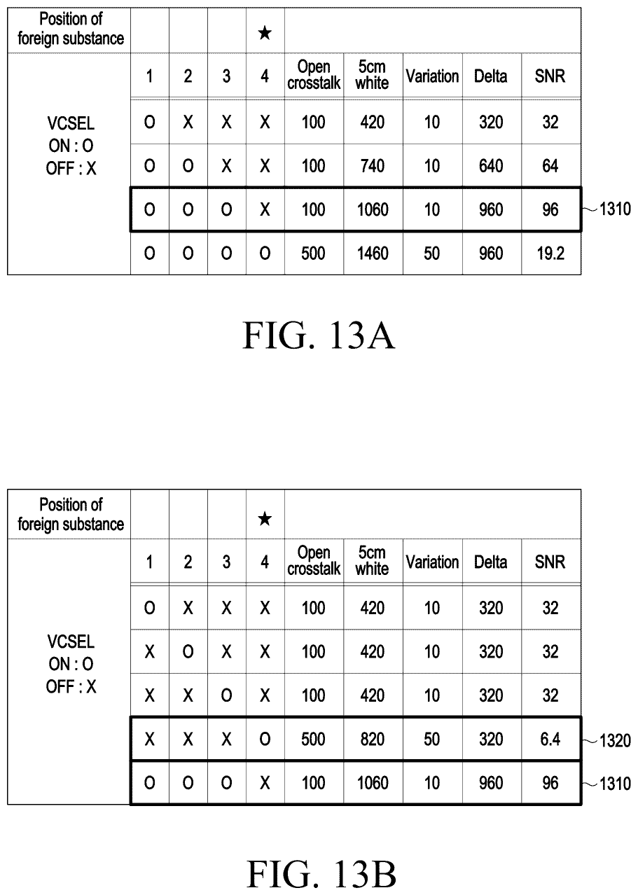

According to an embodiment, the light emitting devices 291a, 291b, 291c, and 291d may be disposed at different positions to emit light to the outside of the electronic device 200 through different slits (e.g., the first slit 221 of FIG. 6) or different areas of the slits. For example, even when any one of the light emitting devices 291a, 291b, 291c, and 291d is at a contaminated position, if at least one of the remaining light emitting devices 291a, 291b, 291c, and 291d is at a non-contaminated position, the sensor module 209 may detect information about the external environment without a deviation in accuracy. The term “information about the external environment” may refer to whether an external object approaches or a distance from the external object. In an embodiment, the electronic device 200 (e.g., the processor 520 of FIG. 1 or the processor 1020 of FIG. 10) may identify the light emitting device at a contaminated position by alternately or sequentially operating any one of the light emitting devices 291a, 291b, 291c, and 291d. This is described again with reference to FIGS. 12 to 13B below.

According to an embodiment, the sensor module 209 (e.g., the light receiving unit 293) may include at least one light receiving element 293a such as a photodiode (PD). The light receiving element 293a may receive or detect light incident through a slit (e.g., the second slit 223 of FIG. 6) of the front plate 220. For example, when light output from at least one of the light emitting devices 291a, 291b, 291c, and 291d is reflected by an external object and incident through the second slit 223, the light receiving unit 293 and/or the light receiving element 293a may receive at least portion of the light, and the processor (e.g., the processor 520 of FIG. 1 or the processor 1020 of FIG. 10) may determine whether an external object (or an external object) approaches or a distance from the external object, based on the light detected by the light receiving unit 293.

FIG. 9 is a diagram illustrating a sensor module of an electronic device according to an embodiment of the disclosure.

Referring to FIG. 9, a sensor module (e.g., the first sensor module 104 of FIG. 2 or the sensor module 209 of FIGS. 6 and 7) and/or a light receiving unit 293 may include a plurality of light receiving elements 293b, 293c, 293d, and 293e. For example, when the light emitting unit 291 includes the plurality of light emitting devices 291a, 291b, 291c, and 291d, the plurality of light receiving elements 293b, 293c, 293d, and 293e may be disposed, and one of the plurality of light receiving elements 293b, 293c, 293d, and 293e may receive light output from at least one from among the light emitting devices 291a, 291b, 291c, and 291d. In an embodiment, when the same number of light receiving elements 293b, 293c, 293d, and 293e as the light emitting devices 291a, 291b, 291c, and 291d are disposed, the light receiving elements 293b, 293c, 293d, and 293e and the light emitting devices 291a, 291b, 291c, and 291d may be configured to correspond to each other in a one-to-one correspondence. However, the embodiment(s) of the disclosure are not limited thereto, and each of the light receiving elements 293b, 293c, 293d, and 293e may receive light output from a plurality of light emitting devices selected from among the light emitting devices 291b, 291c, 291d, and 291e.

In FIGS. 8 and 9, the arrangement of the light emitting devices 291a, 291b, 291c, and 291d or the arrangement of the light receiving elements 293b, 293c, 293d, and 293e is merely an example, and it should be noted that the embodiment(s) of the disclosure are not limited thereto. For example, the plurality of light receiving elements 293b, 293c, 293d, and 293e may be arranged around the light emitting unit 291 along a polygonal or circular trajectory, or may be arranged on one side of the light emitting unit 291 at positions different from the illustrated positions.

FIG. 10 is a diagram illustrating a schematic structure of an electronic device according to an embodiment of the disclosure.

Referring to FIG. 10, an electronic device 1001 may include a processor 1020, memory 1030, and a sensor module 1050. For example, the electronic device 1001 may be implemented to be identical or similar to the electronic device 501 of FIG. 1, the electronic device 100 of FIG. 2, and the electronic device 200 of FIG. 4.

According to an embodiment, the sensor module 1050 may sense whether the external object approaches. The sensor module 1050 may include a light emitting unit 1060 (e.g., a light emitter) and a light receiving unit 1070 (e.g., a light receiver). For example, the light emitting unit 1060 may include a plurality of light sources spaced apart from each other. For example, each of the plurality of light sources may be implemented as a light emitting device. The light receiving unit 1070 may include a plurality of light receiving elements. For example, each of the plurality of light receiving elements may be implemented as a photodiode.

According to an embodiment, the sensor module 1050 may further include a clear mold 1052. For example, the clear mold 1052 may be implemented in a transparent form. For example, the clear mold 1052 may be implemented as a transparent glass. For example, the clear mold 1052 may pass light output from the light emitting unit 1060 and/or light output from the outside. Alternatively, the clear mold 1052 may pass light incident from the outside.

According to an embodiment, the plurality of light sources included in the light emitting unit 1060 may output or radiate light through an opening 1055 of the housing in the front surface of the electronic device 1001. For example, light output or radiated from the plurality of light sources may be output or radiated to the outside through the clear mold 1052 and the opening 1055.

According to an embodiment, the plurality of light receiving elements included in the light receiving unit 1070 may receive light incident from the outside through the opening 1057 of the housing in the front surface of the electronic device 1001. For example, light incident from the outside may be received by a plurality of light receiving elements through the clear mold 1052 and the opening 1057. For example, light incident from the outside may be at least a portion of light output or radiated from the plurality of light sources and reflected by an external object.

According to an embodiment, the processor 1020 may control the overall operation of the electronic device 1001. For example, the processor 1020 may be implemented to be identical or similar to the processor 520 of FIG. 1.

According to an embodiment, in a first state in which the sensor module 1050 is non-obstructed, the processor 1020 may identify a signal corresponding to light output from a plurality of light sources included in the light emitting unit 1060 through the light receiving unit 1070. For example, the first state may mean a state in which an external object does not exist at a position close to the sensor module 1050.

According to an embodiment, the processor 1020 may compare the first value corresponding to the signal identified through the light receiving unit 1070 with the second value stored in the memory 1030. For example, the second value may be a reference value corresponding to the signal identified through the light receiving unit 1070. For example, the second value may be a value corresponding to a signal obtained in a state in which the sensor module 1050 is non-obstructed during a process.

According to an embodiment, the processor 1020 may update the second value based on the signal obtained while the sensor module 1050 is non-obstructed. Further, the updated second value may be stored in the memory 1030.

According to an embodiment, the processor 1020 may identify whether the difference between the first value and the second value exceeds a designated threshold. For example, the processor 1020 may identify whether the change ratio between the first value and the second value exceeds a threshold (e.g., a predetermined ratio, 20%). Based on identifying that the difference between the first value and the second value exceeds the threshold, the processor 1020 may control the light emitting unit 1060 to turn off at least one from among the plurality of light sources included in the light emitting unit 1060. Alternatively, the processor 1020 may control the light emitting unit 1060 to maintain the state (e.g., the on state or the off state) of the plurality of light sources included in the light emitting unit 1060, based on identifying that the difference between the first value and the second value does not exceed the threshold.

According to an embodiment of the disclosure, the processor 1020 may output light from the plurality of light sources included in the light emitting unit 1060 in the first state in which the sensor module 1050 is non-obstructed. Further, the processor 1020 may obtain and identify the first signal corresponding to the light output from the plurality of light sources through the light receiving unit 1070. For example, the processor 1020 may identify a sensing value corresponding to the first signal. For example, the first state may mean a state in which the sensor module 1050 is not close to the external object.

According to an embodiment, the processor 1020 may output light from the plurality of light sources included in the light emitting unit 1060 in a second state in which the sensor module 1050 is obstructed. Further, the processor 1020 may obtain and identify the second signal corresponding to the light output from the plurality of light sources through the light receiving unit 1070. For example, the processor 1020 may identify a sensing value corresponding to the first signal. For example, the second state may mean a state in which the sensor module 1050 is close to the external object. For example, when a sensing value higher than a value (e.g., a 5 cm white value) designated to the sensor module 1050 is detected through the sensor module 1050, the processor 1020 may identify it as the second state.

According to an embodiment, the processor 1020 may identify the first signal and the second signal while sequentially turning on or off each of the plurality of light sources included in the light emitting unit 1060. For example, the processor 1020 may identify the first signal and the second signal while sequentially turning off one light source in a state in which all of the plurality of light sources are turned on. Alternatively, the processor 1020 may identify the first signal and the second signal while sequentially turning on one light source in a state in which all of the plurality of light sources are turned off.

According to an embodiment, the processor 1020 may control the light emitting unit 1060 to turn off the at least one from among the plurality of light sources, based on the first signal identified in the first state and the second signal identified in the second state. For example, the processor 1020 may turn off at least one light source corresponding to the position of the foreign substance among the plurality of light sources. For example, the processor 1020 may identify the strength and/or signal-to-noise ratio (SNR) of the first signal and the second signal. The processor 1020 may identify at least one light source corresponding to the position of the foreign substance among the plurality of light sources based on the identification result.

The processor 1020 may turn off the light source corresponding to the position of the foreign substance among the plurality of light sources and turn on only the remaining light sources. Alternatively, the electronic device 1001 may identify a tilted light source among the plurality of light sources included in the light emitting unit 1060. The electronic device 1001 may turn off the tilted light source among the plurality of light sources included in the light emitting unit 1060 and turn on only the remaining light sources. The processor 1020 may identify whether the external object approaches based on the turned-on light source among the plurality of light sources.

According to an embodiment, the processor 1020 may turn off at least one from among the plurality of light receiving elements (or a plurality of photodiodes) included in the light receiving unit 1070, based on the turned-on light source. In other words, the processor 1020 may turn on only some of the plurality of light receiving elements based on the turned-on light source.

According to an embodiment, in the first state in which the sensor module 1050 is non-obstructed, the processor 1020 may obtain and identify the third signal corresponding to the light output from the turned-on light source through the plurality of light receiving elements included in the light receiving unit 1070. For example, the processor 1020 may identify a sensing value corresponding to the third signal.

According to an embodiment, in the second state in which the sensor module 1050 is obstructed, the processor 1020 may obtain and identify the fourth signal corresponding to the light output from the turned-on light source through the plurality of light receiving elements included in the light receiving unit 1070. For example, the processor 1020 may identify a sensing value corresponding to the fourth signal.

According to an embodiment, the processor 1020 may identify the third signal and the fourth signal while sequentially turning on or off each of the plurality of light receiving elements included in the light receiving unit 1070. For example, the processor 1020 may identify the third signal and the fourth signal while sequentially turning off one light receiving element in a state in which all of the plurality of light receiving elements are turned on. Alternatively, the processor 1020 may identify the third signal and the fourth signal while sequentially turning on one light receiving element in a state in which all of the plurality of light receiving elements are turned off.

According to an embodiment, the processor 1020 may control the light receiving unit 1070 to turn off the at least one from among the plurality of light receiving elements, based on the third signal identified in the first state and the fourth signal identified in the second state. For example, the processor 1020 may identify the strength and/or signal-to-noise ratio (SNR) of the third signal and the fourth signal. The processor 1020 may identify the combination having the highest SNR among the combinations of the plurality of light receiving elements based on the identification result. The processor 1020 may turn off the light receiving element in which a signal having a low SNR is identified among the plurality of light receiving elements, and turn on only the remaining light receiving elements. The processor 1020 may identify whether the external object approaches based on the turned-on light receiving element among the plurality of light receiving elements.

The electronic device 1001 according to an embodiment may turn off a light source and/or a light receiving element having reduced accuracy (or sensitivity). Accordingly, in identifying whether an external object approaches using the sensor module 1050, the electronic device 1001 according to an embodiment may enhance accuracy and sensitivity. Further, the electronic device according to an embodiment may reduce unnecessary power consumption by turning off the light source and/or light receiving element with reduced accuracy (or sensitivity).

At least some of the operations of the electronic device 1001 described below may be performed by the processor 1020. However, for convenience of description, the following operations are described as being performed by the electronic device 1001.

FIG. 11 is a diagram illustrating an operation of turning off at least one from among a plurality of light sources included in a sensor module by an electronic device according to an embodiment of the disclosure.

Referring to FIG. 11, according to an embodiment, a light emitting unit 1060 may include a plurality of light sources. For example, the light emitting unit 1060 may include a first light source 1110, a second light source 1120, a third light source 1130, and a fourth light

According to an embodiment, the electronic device 1001 (e.g., the electronic device 1001 of FIG. 10) may turn on the plurality of light sources (e.g., the first light source 1110, the second light source 1120, the third light source 1130, and the fourth light source 1140). A foreign substance 1180 may be positioned on the fourth light source 1140 among the plurality of light sources (e.g., the first light source 1110, the second light source 1120, the third light source 1130, and the fourth light source 1140). For example, the foreign substance 1180 may enter the light emitting unit 1060 in a process step or a process of using the electronic device 1001. Further, due to contamination or dust caused by oil on the front plate 102 of the electronic device 1001, a foreign substance 1080 may enter the light emitting unit 1060. As the foreign substance 1180 is positioned on the fourth light source 1140, the intensity or amount of light emitted or output through the fourth light source 1140 may be reduced. Accordingly, a signal due to light emitted or output through the fourth light source 1140 may have a low SNR value.

According to an embodiment, the electronic device 1001 may turn off the fourth light source 1140 among the plurality of light sources (e.g., the first light source 1110, the second light source 1120, the third light source 1130, and the fourth light source 1140). In other words, the electronic device 1001 may turn off the fourth light source 1140 having reduced accuracy (or sensitivity). The electronic device 1001 may turn on the first light source 1110, the second light source 1120, and the third light source 1130. The electronic device 1001 may identify whether the external object approaches based on the first light source 1110, the second light source 1120, and the third light source 1130. Accordingly, in identifying whether an external object approaches using the sensor module 1050, the electronic device 1001 according to an embodiment may enhance accuracy and sensitivity.

In the following embodiments, each operation may be performed sequentially, but is not necessarily performed sequentially. For example, the order of the operations may be changed, and at least two operations may be performed in parallel.

According to an embodiment, it may be understood that operations 1201 to 1203 and operations 1211 to 1223 are performed by a processor (e.g., the processor 1020 of FIG. 10) of an electronic device (e.g., the electronic device 1001 of FIG. 10).

FIG. 12A is a flowchart illustrating an operation of turning off at least one from among a plurality of light sources included in a sensor module by an electronic device according to an embodiment of the disclosure.

Referring to FIG. 12A, according to an embodiment, in operation 1201, in the first state in which the sensor module 1050 (e.g., the sensor module 1050 of FIG. 10) is non-obstructed, the electronic device 1001 (e.g., the electronic device 1001 of FIG. 10) may identify a signal corresponding to light output from the plurality of light sources included in the light emitting unit 1060 of the sensor module 1050 through the light receiving unit 1070 of the sensor module 1050. The electronic device 1001 may identify a first value corresponding to the corresponding signal.

According to an embodiment, in operation 1203, the electronic device 1001 may compare the first value corresponding to the signal with the second value stored in the memory (e.g., the memory 1030 of FIG. 10).

According to an embodiment, in operation 1205, the electronic device 1001 may control the light emitting unit 1060 to turn off at least one of the plurality of light sources included in the light emitting unit 1060, based on identifying that the difference between the first value and the second value exceeds the threshold.

Meanwhile, a more detailed operation in which the electronic device 1001 turns off at least one of the plurality of light sources included in the light emitting unit 1060 is described with reference to FIG. 12B below.

FIG. 12B is a flowchart illustrating an operation of turning off at least one from among a plurality of light sources included in a sensor module by an electronic device according to an embodiment of the disclosure.

Referring to FIG. 12B, according to an embodiment, in operation 1211, in the first state in which the sensor module 1050 (e.g., the sensor module 1050 of FIG. 10) is non-obstructed, the electronic device 1001 (e.g., the electronic device 1001 of FIG. 10) may identify a signal corresponding to light output from the plurality of light sources included in the light emitting unit 1060 of the sensor module 1050 through the light receiving unit 1070 of the sensor module 1050. The electronic device 1001 may identify a first value corresponding to the corresponding signal.

According to an embodiment, in operation 1213, the electronic device 1001 may compare the first value corresponding to the signal with the second value stored in the memory (e.g., the memory 1030 of FIG. 10). In operation 1215, the electronic device 1001 may identify whether the difference between the first value and the second value exceeds a threshold. For example, the electronic device 1001 may identify whether a change between the first value and the second value exceeds a threshold ratio (e.g., 20%) based on the second value.

According to an embodiment, when it is identified that the difference between the first value and the second value does not exceed the threshold (No in operation 1215), in operation 1217, the electronic device 1001 may maintain the on (or off) state of the plurality of light sources.

According to an embodiment, when it is identified that the difference between the first value and the second value exceeds the threshold (YES in operation 1215), in operation 1219, the electronic device 1001 may identify the first signal by sequentially turning on or off each of the plurality of light sources included in the light emitting unit 1060 in the first state of the sensor module 1050.

According to an embodiment, in operation 1221, the electronic device 1001 may identify the second signal by sequentially turning on or off each of the plurality of light sources included in the light emitting unit 1060 in the second state in which the sensor module 1050 is close to the external object.

According to an embodiment, in operation 1223, the electronic device 1001 may turn off at least one from among the plurality of light sources included in the light emitting unit 1060, based on the first signal and the second signal. For example, the electronic device 1001 may obtain an SNR value by dividing a variation value (10% of the open crosstalk value) by a difference (e.g., delta value) between a sensing value (e.g., open crosstalk value) of the first signal and a sensing value (e.g., 5 cm white value) of the second signal. For example, the electronic device 1001 may identify the light source, which, when turned off, allows the highest SNR value (or the lowest SNR value) to be obtained among the plurality of light sources through the first signal and the first signal. The electronic device 1001 may determine which of the plurality of light sources is to be turned on/off, according to the identification result. For example, the electronic device 1001 may turn off the light source corresponding to the position of the foreign substance among the plurality of light sources included in the light emitting unit 1060. Alternatively, the electronic device 1001 may turn off the tilted light source among the plurality of light sources included in the light emitting unit 1060.

According to an embodiment, the electronic device 1001 may store a sensing value obtained based on the determined combination of the turned-on light sources in memory (e.g., the memory 1030 of FIG. 10). The stored value may be used as the second value in the future.

According to an embodiment, the electronic device 1001 may identify whether the external object approaches based on the turned-on light receiving element among the plurality of light receiving elements. Accordingly, in identifying whether an external object approaches using the sensor module 1050, the electronic device 1001 according to an embodiment may enhance accuracy and sensitivity.

FIGS. 13A and 13B are diagrams illustrating an operation of turning off at least one from among a plurality of light sources included in a sensor module by an electronic device according to an embodiment of the disclosure.

Referring to FIGS. 13A and 13B, an electronic device 1001 (e.g., the electronic device 1001 of FIG. 10) may radiate or output light from a plurality of light sources included in a light emitting unit 1060 (e.g., the light emitting unit 1060 of FIG. 10). The electronic device 1001 may obtain and identify a signal corresponding to the emitted or output light through the light receiving unit 1070 (e.g., the light receiving unit 1070 of FIG. 10). The electronic device 1001 may identify values (or sensing values) corresponding to the corresponding signal. For example, the electronic device 1001 may identify an open crosstalk value, a 5 cm white value, a variation value, a delta value, and an SNR value based on the corresponding signal. For example, the “open crosstalk” value may be a value (or sensitivity) corresponding to a signal obtained through the light receiving unit 1070 in a state where there is no external object near the sensor module 1050. The “5 cm white” value may be a value (or sensitivity) corresponding to a signal obtained based on the 5 cm white reflector. The “variation” value may be a value corresponding to about 10% of the open crosstalk. The “delta” value may be a value obtained by subtracting the open crosstalk value from the 5 cm white value. The signal-to-noise ratio (“SNR”) value may be a value obtained by dividing the delta value by the variation value. The electronic device 1001 may determine a combination of light sources having the highest signal-to-noise ratio (e.g., a combination of light sources to be turned on) as an optimal combination.

According to an embodiment, when there is a foreign substance on the fourth light source among the plurality of light sources (e.g., VCSEL) included in the light emitting unit 1060, the electronic device 1001 may identify a signal corresponding to light output from the plurality of light sources through the light receiving unit 1070. The electronic device 1001 may identify a sensing value or sensitivity based on the corresponding signal. When all of the plurality of light sources are turned on, the open crosstalk value may be 500. Since there is a foreign substance positioned above the fourth light source, the difference (or delta value) between the open crosstalk value and the 5 cm white value may be 0 (or may be approximate to 0). The delta value obtained from each of the remaining light sources without foreign substances may be 320. In other words, when all of the plurality of light sources are turned on, the delta value for the plurality of light sources may be 960 (e.g., 320*3+0=960). A noise fluctuation corresponding to 10% may occur in the open crosstalk. The variation according to the noise fluctuation (or noise variation) may be 50 which is 10% of the open crosstalk. The signal-to-noise ratio (SNR) may be obtained by comparing the variation with the delta (e.g., the ratio of sensitivity) corresponding to the difference between the 5 cm white value and the open crosstalk value. For example, in FIG. 13A, when all of the plurality of light sources are turned on, if the open crosstalk is 500, and the 5 cm white value is 1460, the SNR value may be 19.2.

Referring to FIG. 13A, according to an embodiment, the electronic device 1001 may sequentially turn on the plurality of light sources included in the light emitting unit 1060 in the first state or the second state of the sensor module 1050. For example, the electronic device 1001 may turn on the first light source with all of the plurality of light sources turned off. In this case, the electronic device 1001 may identify the open crosstalk value and the 5 cm white value while the first light source is turned on. For example, the electronic device 1001 may identify the open crosstalk value in the first state in which the sensor module 1050 is non-obstructed. The electronic device 1001 may identify the 5 cm white value in the second state in which the sensor module 1050 is close to the external object (e.g., the reflector spaced apart by a distance of 5 cm). Thereafter, the electronic device 1001 may identify the SNR value (e.g., 32) in a state in which the first light source is turned on. The electronic device 1001 may sequentially turn on the remaining light sources with the first light source turned on. In this case, the electronic device 1001 may identify the SNR value while sequentially turning on the remaining light sources.

According to an embodiment, the electronic device 1001 may identify that the corresponding SNR value (e.g., 96) is the highest, based on the values 1310 obtained with only the fourth light source turned off. The electronic device 1001 may identify that a foreign substance is positioned on the fourth light source, based on the identification result. The electronic device 1001 may determine that the state in which the fourth light source is turned off and the first light source, the second light source, and the third light source are turned on is an optimal light source combination.

Referring to FIG. 13B, the electronic device 1001 (e.g., the electronic device 1001 of FIG. 10) may sequentially turn on the plurality of light sources included in the light emitting unit 1060 in the first state or the second state of the sensor module 1050.

The electronic device 1001 may sequentially turn on any one from among the plurality of light sources included in the light emitting unit 1060, when the sensor module 1050 is in the first state or the second state. For example, the electronic device 1001 may turn on only the first light source with all others of the plurality of light sources turned off. In this case, the electronic device 1001 may identify the open crosstalk value and the 5 cm white value while the first light source is turned on. For example, the electronic device 1001 may identify the open crosstalk value in the first state in which the sensor module 1050 is non-obstructed. The electronic device 1001 may identify the 5 cm white value in the second state in which the sensor module 1050 is close to the external object (e.g., the reflector spaced apart by a distance of 5 cm). Thereafter, the electronic device 1001 may identify the SNR value (e.g., 32) in a state in which the first light source is turned on. Thereafter, the electronic device 1001 may sequentially turn on only one of the remaining light sources. In this case, the electronic device 1001 may identify the SNR value while sequentially turning on any one of the remaining light sources.

According to an embodiment, the electronic device 1001 may identify that the corresponding SNR value (e.g., 6.4) is the smallest, based on the values 1320 obtained with only the fourth light source turned on. Further, the electronic device 1001 may identify that the SNR values (e.g., 32) are all the same in the state in which each of the remaining light sources is turned on. The electronic device 1001 may identify that a foreign substance is positioned on the fourth light source, based on the identification result. The electronic device 1001 may determine that the state in which the fourth light source is turned off and the first light source, the second light source, and the third light source are turned on is an optimal light source combination.

According to an embodiment, the higher the signal strength, the higher the SNR value. Therefore, when the remaining light sources other than the fourth light source are turned on, the SNR may be the highest. Accordingly, the electronic device 1001 may determine a combination having the highest SNR, that is, a combination of turning on the first light source, the second light source, and the third light source, as an optimal combination. According to the implementation, the light emitting unit 1060 may be controlled to supply a minimum current without turning off the fourth light source. Alternatively, a method of enhancing the SNR by supplying a higher current to the fourth light source having a lower open crosstalk value may be applied. According to an embodiment, in order to prevent malfunction due to temperature drift, the electronic device 1001 may determine a combination for minimizing an open crosstalk value as an optimal combination because the lower the total open crosstalk value, the more advantageous it is.

The method of determining which light source is to be turned off and which light source is to be turned on among the plurality of light sources described with reference to FIGS. 13A and 13B is merely an example, and embodiments of the disclosure may not be limited thereto. The electronic device 1001 of embodiment of the disclosure may determine an optimal combination according to other various methods.

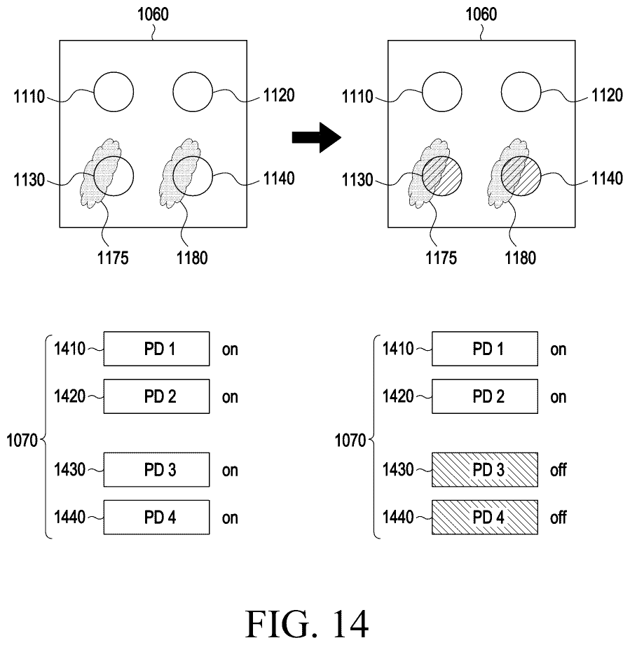

FIG. 14 is a diagram illustrating an operation of turning off at least one from among a plurality of photodiodes included in a sensor module by an electronic device according to an embodiment of the disclosure.

Referring to FIG. 14, according to an embodiment, a light emitting unit 1060 may include a plurality of light sources. For example, the light emitting unit 1060 may include a first light source 1110, a second light source 1120, a third light source 1130, and a fourth light

According to an embodiment, a light receiving unit 1070 may include a plurality of light receiving elements (e.g., the first light receiving element 1410, the second light receiving element 1420, the third light receiving element 1430, and the fourth light receiving element 1440). Each of the plurality of light receiving elements may be implemented as a photodiode (PD). For example, the light receiving unit 1070 may include a first light receiving element 1410 (e.g., a first light receiving element PD), a second light receiving element 1420 (e.g., a second light receiving element PD), a third light receiving element 1430 (e.g., a third light receiving element PD), and a fourth light receiving element 1440 (e.g., a fourth light receiving element PD).

According to an embodiment, the electronic device 1001 (e.g., the electronic device 1001 of FIG. 10) may turn off at least one from among the plurality of light sources (e.g., the first light source 1110, the second light source 1120, the third light source 1130, and the fourth light source 1140). For example, each of foreign substances 1175 and 1180 may be at least partially positioned on the third light source 1130 and the fourth light source 1140. As the foreign substances 1175 and 1180 are at least partially positioned on the third light source 1130 and the fourth light source 1140, the intensity or amount of light emitted or output through the third light source 1130 and the fourth light source 1140 may be reduced. Accordingly, a signal according to the light emitted or output through the third light source 1130 and the fourth light source 1140 may have a low SNR value. Accordingly, the electronic device 1001 may turn off the third light source 1130 and the fourth light source 1140, the accuracy (or sensitivity) of which is reduced due to the foreign substances 1175 and 1180. The electronic device 1001 may turn on the first light source 1110 and the second light source 1120. The electronic device 1001 may identify whether the external object approaches based on the first light source 1110 and the second light source 1120.

According to an embodiment, the electronic device 1001 may turn off at least one of the plurality of light receiving elements (e.g., the first light receiving element 1410, the second light receiving element 1420, the third light receiving element 1430, and the fourth light receiving element 1440). For example, the electronic device 1001 may turn off at least one of the plurality of light receiving elements (e.g., the first light receiving element 1410, the second light receiving element 1420, the third light receiving element 1430, and the fourth light receiving element 1440) based on the turned-on light sources (e.g., the first light source 1110 and the second light source 1120). In other words, the electronic device 1001 may turn on only some of the plurality of light receiving elements (e.g., the first light receiving element 1410, the second light receiving element 1420, the third light receiving element 1430, and the fourth light receiving element 1440) based on the turned-on light sources (e.g., the first light source 1110 and the second light source 1120).

According to an embodiment, as the third light source 1130 and the fourth light source 1140 are turned off, some of the plurality of light receiving elements (e.g., the first light receiving element 1410, the second light receiving element 1420, the third light receiving element 1430, and the fourth light receiving element 1440) may receive a signal having a low intensity and/or SNR. For example, as the third light source 1130 and the fourth light source 1140 are turned off, the third light receiving element PD3 1430 and the fourth light receiving element PD4 1440 may receive signals having low intensity and/or SNR. Accordingly, the electronic device 1001 may turn off the third light receiving element PD3 1430 and the fourth light receiving element PD4 1440. Further, the electronic device 1001 may turn on the first light receiving element PD1 1410 and the second light receiving element PD2 1420. The electronic device 1001 may identify whether the external object approaches based on the first light receiving element PD1 1410 and the second light receiving element PD2 1420.

Accordingly, in identifying whether an external object approaches using the sensor module 1050, the electronic device 1001 according to an embodiment may enhance accuracy and sensitivity. Further, the electronic device according to an embodiment may reduce unnecessary power consumption by turning off the light source and/or light receiving element with reduced accuracy (or sensitivity).

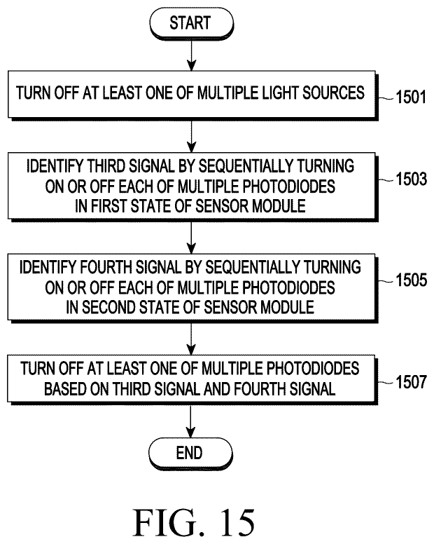

FIG. 15 is a flowchart illustrating an operation of turning off at least one from among a plurality of photodiodes included in a sensor module by an electronic device according to an embodiment of the disclosure.

In the following embodiments, each operation may be performed sequentially, but is not necessarily performed sequentially. For example, the order of the operations may be changed, and at least two operations may be performed in parallel.

According to an embodiment, operations 1501 to 1507 may be understood as performed by a processor (e.g., the processor 1020 of FIG. 10) of an electronic device (e.g., the electronic device 1001 of FIG. 10).

Referring to FIG. 15, according to an embodiment, in operation 1501, the electronic device 1001 may turn off at least one from among the plurality of light sources (e.g., the first light source 1110, the second light source 1120, the third light source 1130, and the fourth light source 1140). The electronic device 1001 may turn on only some of the plurality of light sources (e.g., the first light source 1110, the second light source 1120, the third light source 1130, and the fourth light source 1140).

According to an embodiment, in operation 1503, in the first state in which the sensor module 1050 is non-obstructed, the electronic device 1001 may sequentially turn on or off each of the plurality of photodiodes included in the light receiving unit 1070 to obtain and identify a third signal.

According to an embodiment, in operation 1505, the electronic device 1001 may obtain and identify a fourth signal by sequentially turning on or off each of the plurality of photodiodes included in the light receiving unit 1070 in the second state in which the sensor module 1050 is close to the external object.

According to an embodiment, in operation 1507, the electronic device 1001 may turn off at least one from among the plurality of photodiodes included in the light receiving unit 1070, based on the third signal and the fourth signal. For example, the electronic device 1001 may obtain an SNR value by dividing a variation value (10% of the open crosstalk value) by a difference (e.g., delta value) between a sensing value (e.g., open crosstalk value) of the third signal and a sensing value (e.g., 5 cm white value) of the fourth signal. For example, the electronic device 1001 may identify the photodiode, which, when turned off, allows the highest SNR value (or the lowest SNR value) to be obtained among the plurality of photodiodes through the third signal and the fourth signal. The electronic device 1001 may determine which of the plurality of photodiodes is to be turned on/off, according to the identification result. Further, the electronic device 1001 may store a sensing value obtained based on the determined combination of the turned-on photodiodes in memory (e.g., the memory 1030 of FIG. 10). The stored value may be used as the second value in the future.

The electronic device 1001 according to an embodiment may determine an optimal combination of a plurality of photodiodes in the same or similar manner as the method described with reference to FIGS. 13A and 13B. For example, the electronic device 1001 may determine a photodiode to be turned on/off among the plurality of photodiodes, based on the SNR value obtained with at least one of the plurality of photodiodes turned on/off.

According to an embodiment, the electronic device 1001 may identify whether the external object approaches based on the turned-on light receiving element among the plurality of light receiving elements. Accordingly, in identifying whether an external object approaches using the sensor module 1050, the electronic device 1001 according to an embodiment may enhance accuracy and sensitivity.

According to an embodiment of the disclosure, it is possible to allow the electronic device to have a better exterior appearance by reducing the width or length of the slit, slot, or opening in forming an air inflow path or a light incident path. For example, the exterior quality of the electronic device may be enhanced. In an embodiment, it is possible to suppress deterioration of optical efficiency or power efficiency although the slit width or length is reduced by utilizing a light source with a small radiation angle, such as a vertical-cavity surface-emitting laser, when disposing a sensor module for radiating or receiving light. In an embodiment, as the sensor module or light emitting unit includes a plurality of light emitting devices radiating light to the outside through different areas or different positions, deterioration of accuracy of the sensor module due to contamination may be suppressed although the slit width or length or the radiation angle of the light emitting unit is reduced.

Effects obtainable from the disclosure are not limited to the above-mentioned effects, and other effects not mentioned may be apparent to one of ordinary skill in the art from the above and below description.

An electronic device 501, 502, 504, 100, 200, or 1001 according to an embodiment may comprise a housing including a front surface and a rear surface facing in a direction opposite to a facing direction of the front surface, a display 560 or 230 disposed inside the housing and configured to output a screen through at least a portion of the front surface, a sensor module 1050 disposed inside the housing and configured to emit light through the front surface, receive at least a portion of light incident from an outside of the housing, and sense whether an external object approaches, memory 1030, and a processor 1020. The sensor module 1050 according to an embodiment may include a light emitting unit 1060 including a plurality of light sources spaced apart from each other and configured to emit light through the front surface, and a light receiving unit 1070 configured to receive at least a portion of the light incident from the outside of the housing through the front surface. The processor according to an embodiment may be configured to obtain (e.g., identify), through the light receiving unit, a signal corresponding to light output from the plurality of light sources in a first state in which the sensor module is non-obstructed. The processor according to an embodiment may be configured to compare a first value corresponding to the signal with a second value stored in the memory. The processor according to an embodiment may be configured to control the light emitting unit to turn off at least one from among the plurality of light sources based on identifying that a difference between the first value and the second value exceeds a threshold.

The processor according to an embodiment may be configured to obtain (e.g., identify), through the light receiving unit, a first signal corresponding to the light output from the plurality of light sources in the first state. The processor according to an embodiment may be configured to obtain (e.g., identify), through the light receiving unit, a second signal corresponding to the light output from the plurality of light sources in a second state in which the sensor module approaches the external object. The processor according to an embodiment may be configured to control the light emitting unit to turn off the at least one from among the plurality of light sources based on the first signal and the second signal.

The processor according to an embodiment may be configured to obtain (e.g., identify) the first signal and the second signal while sequentially turning on each of the plurality of light sources.

The processor according to an embodiment may be configured to obtain (e.g., identify) the first signal and the second signal while sequentially turning off each of the plurality of light sources.

The processor according to an embodiment may be configured to turn off the at least one light source based on at least one foreign substance corresponding to a position of the at least one light source.

The light receiving unit according to an embodiment may include a plurality of photodiodes.

The processor according to an embodiment may be configured to obtain (e.g., identify), through the light receiving unit, a third signal corresponding to light output from a turned-on at least one light source among the plurality of light sources in the first state. The processor according to an embodiment may be configured to obtain (e.g., identify), through the light receiving unit, a fourth signal corresponding to light output from the turned-on at least one light source among the plurality of light sources in the second state. The processor according to an embodiment may be configured to control the light receiving unit to turn off at least one from among the plurality of photodiodes based on the third signal and the fourth signal.

The processor according to an embodiment may be configured to identify the third signal and the fourth signal while sequentially turning on each of the plurality of photodiodes.

The processor according to an embodiment may be configured to obtain (e.g., identify) the third signal and the fourth signal while sequentially turning off each of the plurality of photodiodes.

The electronic device according to an embodiment may further comprise a guide member including a partition disposed between the light emitting unit and the light receiving unit, wherein the sensor module is mounted on the guide member.

In a method for operating an electronic device 501, 502, 504, 100, 200, or 1001, the electronic device may include a housing including a front surface and a rear surface facing in a direction opposite to a facing direction of the front surface, a display 560 or 230 disposed inside the housing and configured to output a screen through at least a portion of the front surface, and a sensor module 1050 disposed inside the housing and configured to emit light through the front surface, receive at least a portion of light incident from an outside of the housing, and sense whether an external object approaches, the sensor module including a light emitting unit 1060 including a plurality of light sources spaced apart from each other and configured to emit light through the front surface and a light receiving unit 1070 configured to receive the light incident from the outside of the housing through the front surface. The operation method of the electronic device according to an embodiment may comprise obtaining (e.g., identifying), through the light receiving unit, a signal corresponding to light output from the plurality of light sources in a first state in which the sensor module is non-obstructed. The operation method of the electronic device 100 or 1001 according to an embodiment may comprise comparing a first value corresponding to the signal with a second value stored in the memory. The operation method of the electronic device 100 or 1001 according to an embodiment may comprise controlling the light emitting unit to turn off at least one from among the plurality of light sources based on identifying that a difference between the first value and the second value exceeds a threshold.

Controlling the light emitting unit to turn off the at least one from among the plurality of light sources, according to an embodiment, may include obtaining (e.g., identifying), through the light receiving unit, a first signal corresponding to the light output from the plurality of light sources in the first state. Controlling the light emitting unit to turn off the at least one from among the plurality of light sources, according to an embodiment, may include obtaining (e.g., identifying), through the light receiving unit, a second signal corresponding to the light output from the plurality of light sources in a second state in which the sensor module approaches the external object. Controlling the light emitting unit to turn off the at least one from among the plurality of light sources, according to an embodiment, may include controlling the light emitting unit to turn off the at least one from among the plurality of light sources based on the first signal and the second signal.

The operation method of the electronic device according to an embodiment may further comprise obtaining (e.g., identifying) the first signal and the second signal while sequentially turning on each of the plurality of light sources.

The operation method of the electronic device according to an embodiment may further comprise obtaining (e.g., identifying) the first signal and the second signal while sequentially turning off each of the plurality of light sources.

Controlling the light emitting unit to turn off the at least one from among the plurality of light sources, according to an embodiment, may include turning off the at least one light source based on at least one foreign substance corresponding to a position of the at least one light source.

The light receiving unit according to an embodiment may include a plurality of photodiodes.

The operation method of the electronic device according to an embodiment may comprise obtaining (e.g., identifying), through the light receiving unit, a third signal corresponding to light output from a turned-on at least one light source among the plurality of light sources in the first state. The operation method of the electronic device according to an embodiment may comprise obtaining (e.g., identifying), through the light receiving unit, a fourth signal corresponding to light output from the turned-on at least one light source among the plurality of light sources in the second state. The operation method of the electronic device according to an embodiment may further comprise controlling the light receiving unit to turn off at least one from among the plurality of photodiodes based on the third signal and the fourth signal.

The operation method of the electronic device according to an embodiment may further comprise obtaining (e.g., identifying) the third signal and the fourth signal while sequentially turning on each of the plurality of photodiodes.

The operation method of the electronic device according to an embodiment may further comprise identifying the third signal and the fourth signal while sequentially turning off each of the plurality of photodiodes.

In a non-transitory storage medium 530 or 1030 storing a program according to an embodiment, the program may, when executed by a processor 1020 of an electronic device 501, 502, 504, 100, 200, or 1001, enable the electronic device to execute obtaining (e.g., identifying), through a light receiving unit of a sensor module sensing whether the electronic device approaches, a signal corresponding to light output from a plurality of light sources included in a light emitting unit of the sensor module in a first state in which the sensor module is non-obstructed, comparing a first value corresponding to the signal with a second value stored in the electronic device, and controlling the light emitting unit to turn off at least one from among the plurality of light sources based on identifying that a difference between the first value and the second value exceeds a threshold.

While non-limiting example embodiments of the disclosure have been described with reference to the accompanying drawings, it should be appreciated by one of ordinary skill in the art that various changes may be made in form and detail without departing from the spirit and scope of the disclosure.

The electronic device according to embodiment(s) of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

An embodiment(s) of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device). For example, a processor (e.g., the processor) of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities. Some of the plurality of entities may be separately disposed in different components. According to embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a housing comprising a front surface facing in a first direction and a rear surface facing in a second direction opposite to the first direction;
a display in the housing and configured to output a screen through at least a portion of the front surface;
a sensor in the housing and configured to emit light through the front surface, receive at least a portion of light incident from an outside of the housing, and sense whether an external object approaches;
a memory; and
a processor,
wherein the sensor comprises:
a light emitter comprising a plurality of light sources spaced apart from each other, the plurality of light sources configured to emit light through the front surface; and
a light receiver configured to receive at least a portion of the light incident from the outside of the housing through the front surface, and
wherein the processor is configured to:
obtain, through the light receiver, a first signal corresponding to light output from the plurality of light sources in a first state in which the sensor is non-obstructed;
compare a first value corresponding to the first signal with a second value stored in the memory; and
control the light emitter to turn off at least one from among the plurality of light sources based on identifying that a difference between the first value and the second value exceeds a threshold.

2. The electronic device of claim 1, wherein the processor is further configured to:
obtain, through the light receiver, a second signal corresponding to the light output from the plurality of light sources in a second state in which the sensor is obstructed by the external object; and
control the light emitter to turn off the at least one from among the plurality of light sources based on the first signal and the second signal.

3. The electronic device of claim 2, wherein the processor is further configured to obtain the first signal and the second signal while sequentially turning on each of the plurality of light sources.

4. The electronic device of claim 2, wherein the processor is further configured to obtain the first signal and the second signal while sequentially turning off each of the plurality of light sources.

5. The electronic device of claim 1, wherein the processor is further configured to turn off at least one light source, from among the plurality of light sources, based on at least one foreign substance corresponding to a position of the at least one light source.

6. The electronic device of claim 1, wherein the light receiver comprises a plurality of photodiodes.

7. The electronic device of claim 6, wherein the processor is further configured to:
obtain, through the light receiver, a second signal corresponding to light output from at least one light source that is turned on among the plurality of light sources in the first state;
obtain, through the light receiver, a third signal corresponding to light output from the at least one light source among the plurality of light sources in a second state in which the sensor is obstructed by the external object; and
control the light receiver to turn off at least one from among the plurality of photodiodes based on the second signal and the third signal.

8. The electronic device of claim 7, wherein the processor is further configured to obtain the second signal and the third signal while sequentially turning on each of the plurality of photodiodes.

9. The electronic device of claim 7, wherein the processor is further configured to obtain the second signal and the third signal while sequentially turning off each of the plurality of photodiodes.

10. The electronic device of claim 1, further comprising a guide member comprising a partition between the light emitter and the light receiver,
wherein the sensor is on the guide member.

11. A method for operating an electronic device including a housing including a front surface facing in first direction and a rear surface facing in a second direction opposite to the first direction, a display in the housing and configured to output a screen through at least a portion of the front surface, and a sensor in the housing and configured to emit light through the front surface, receive at least a portion of light incident from an outside of the housing, and sense whether an external object approaches, the method comprising:
obtaining, through a light receiver of the sensor, a first signal corresponding to light output from a plurality of light sources of a light emitter of the sensor, in a first state in which the sensor is non-obstructed;
comparing a first value corresponding to the first signal with a second value stored in a memory of the electronic device; and
controlling the light emitter to turn off at least one from among the plurality of light sources based on identifying that a difference between the first value and the second value exceeds a threshold,
wherein the plurality of light sources are spaced apart from each other and configured to emit light through the front surface, and
wherein the light receiver is configured to receive at least a portion of the light incident from the outside of the housing through the front surface.

12. The method of claim 11, further comprising obtaining, through the light receiver, a second signal corresponding to the light output from the plurality of light sources in a second state in which the sensor is obstructed by the external object,
wherein the controlling comprises controlling the light emitter to turn off the at least one from among the plurality of light sources based on the first signal and the second signal.

13. The method of claim 12, further comprising obtaining the first signal and the second signal while sequentially turning on each of the plurality of light sources.

14. The method of claim 12, further comprising obtaining the first signal and the second signal while sequentially turning off each of the plurality of light sources.

15. The method of claim 11, wherein the controlling comprises turning off at least one light source, from among the plurality of light sources, based on at least one foreign substance corresponding to a position of the at least one light source.

16. The method of claim 11, wherein the light receiver includes a plurality of photodiodes.

17. The method of claim 16, further comprising:
obtaining, through the light receiver, a second signal corresponding to light output from at least one light source that is turned on among the plurality of light sources in the first state; and
obtaining, through the light receiver, a third signal corresponding to light output from the at least one light source among the plurality of light sources in a second state in which the sensor is obstructed by the external object,
wherein the controlling comprises controlling the light receiver to turn off at least one from among the plurality of photodiodes based on the second signal and the third signal.

18. The method of claim 17, further comprising obtaining the second signal and the third signal while sequentially turning on each of the plurality of photodiodes.

19. The method of claim 17, further comprising obtaining the second signal and the third signal while sequentially turning off each of the plurality of photodiodes.

20. A non-transitory computer readable medium comprising computer instructions that are configured to, when executed by at least one processor of an electronic device, cause the electronic device to:
obtain, through a light receiver of a sensor of the electronic device, a first signal corresponding to light output from a plurality of light sources, of a light emitter of the sensor, in a first state in which the sensor is non-obstructed;
compare a first value corresponding to the first signal with a second value stored in a memory of the electronic device; and
control the light emitter to turn off at least one from among the plurality of light sources based on identifying that a difference between the first value and the second value exceeds a threshold,
wherein the sensor is configured to sense whether an external object approaches.
